(19) United States
(12) Patent Application Publication
(10) Pub. No.: US 2023/0015114 A1
(43) Pub. Date: Jan. 19, 2023

(54) Method of Operating a Powered Air-Purifying Respirator Assembly

(71) Applicant: CROSS Equipment, LLC, Washington, MI (US)

(72) Inventors: Thomas A. Gillespie, Macomb, MI (US); John P. Bergmann, Washington, MI (US)

(21) Appl. No.: 17/864,086

(22) Filed: Jul. 13, 2022

Related U.S. Application Data
(60) Provisional application No. 63/221,091, filed on Jul. 13, 2021.

(51) Int. Cl. A62B 18/04; A62B 7/10

(52) U.S. Cl. CPC A62B 18/045; A62B 7/10

(57) ABSTRACT

A method alerts a user that a volume of air being circulated through a powered air purifying respirator assembly is outside an acceptable range. The powered air purifying respirator assembly includes a fan and a hood system. The method begins with the step of measuring airflow through the powered air purifying respirator assembly to create a measured airflow value. The measured airflow value is compared to a predetermined high airflow value and a predetermined low airflow value. And, after a predetermined amount of time, an alarm signal is generated when the measured airflow value is either greater than or less than the predetermined high airflow value or the predetermined low airflow value, respectively. During the time when the incorrect airflow is occurring, the motor of the fan may be adjusted to correct the airflow values before the alarm signal is generated.

### BACKGROUND OF THE INVENTION

### 1. Field of the Invention

The invention relates to a powered air-purifying respirator assembly. More particularly, the invention relates to a powered air-purifying respirator assembly that can warn a user relating to issues with its performance.

### 2. Description of the Related Art

Powered air-purifying respirators (PAPRs) create a positive airflow that is filtered or purified to meet a particular specification, depending on the environment and/or deployment of the PAPR. However, the PAPR can only perform optimally or as designed if the PAPR is worn correctly. Many times, the user will not even know the PAPR is not properly fitted, which will minimize the effectiveness of the PAPR.

### SUMMARY OF THE INVENTION

A method alerts a user that a volume of air being circulated through a powered air purifying respirator assembly is outside an acceptable range. The powered air purifying respirator assembly includes a fan and a hood system. The method begins with the step of measuring airflow through the powered air purifying respirator assembly to create a measured airflow value. The measured airflow value is compared to a predetermined high airflow value. And an alarm signal is generated when the measured airflow value is greater than the predetermined high airflow value.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a side view of one embodiment of an assembly;

FIG. 2 is a perspective view of one embodiment of the assembly; and

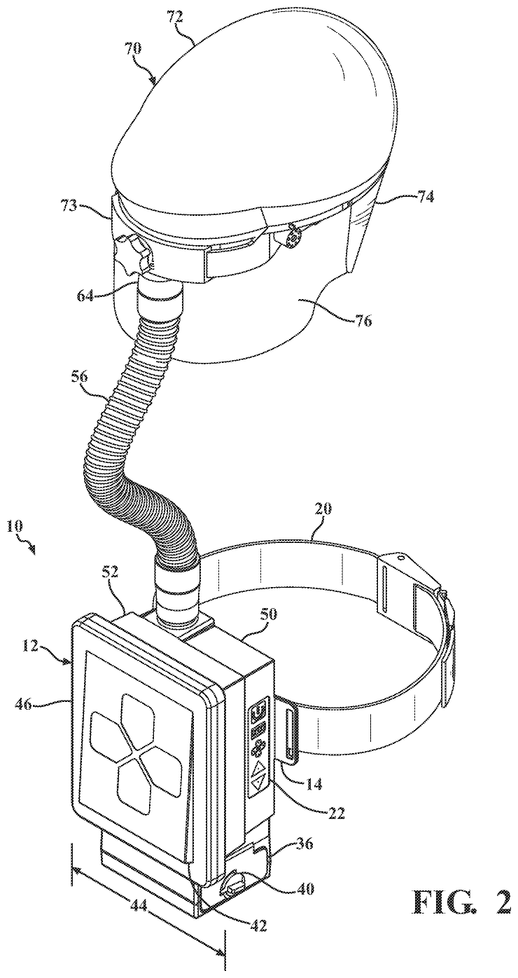

FIG. 3 is a logic chart of a method employed by the assembly.

FIG. 4 is a side view of a person wearing a first alternative embodiment of the assembly; and

FIG. 5 is a side view of a person wearing a second alternative embodiment of the assembly.

### DETAILED DESCRIPTION OF THE INVENTION

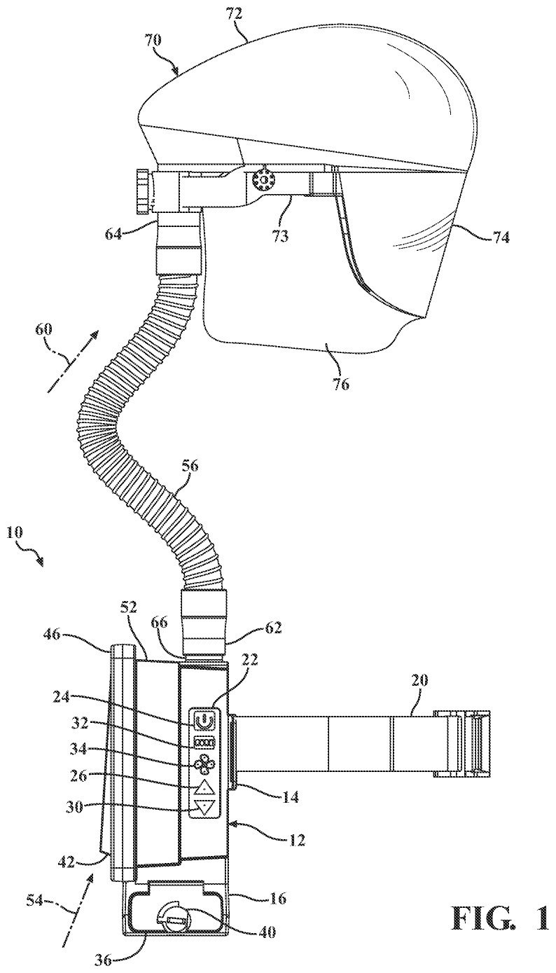

Referring to FIG. 1, one embodiment of the PAPR assembly is generally shown at 10. The PAPR assembly 10 includes a housing, generally indicated at 12. The housing 12 is generally rectangular in shape. A belt clip 14 is fixedly secured to an inner-facing surface 16 of the housing 12 and receives a belt 20 therethrough. The belt 20 is designed to removably secure the housing 12 to a waist of a user (not shown). It should be appreciated by those skilled in the art that the belt clip 14 and the belt 20 may be replaced by other mechanisms that will allow the housing 12 to be removably secured to the user. A non-exhaustive list of alternatives include a shoulder strap or lanyard, a vest, an arm band, and the like.

The housing 12 includes a control panel 22. The control panel 22 includes an on/off button 24, speed control buttons 26, 30 and lights 32, 34 to indicate battery charge and fan speed, respectively.

A battery door 36 provides access to a battery compartment to removably secure a battery (neither shown). The battery provides power to electronics housed within the housing 12. A clasp 40 selectively locks and unlocks the battery door 36.

The housing 12 also includes an inlet port 42. The inlet port 42 extends along a substantial portion of the width 44 of the housing 12. In the embodiment shown, the inlet port 42 is a long thin opening that extends proud of an exterior surface 46 of the housing 12.

The housing 12 includes two primary chambers. The first chamber 50 is the electronics chamber. The electronics chamber 50 houses the electronics that control the PAPR assembly 10. The control panel 22 is electrically connected to the electronics (not shown) housed within the electronics chamber 50. A second chamber 52 houses the filter media (not shown) used to filter air that is received through the inlet port 42, as shown by an air flow arrow 54. The air is pulled into the filter media chamber 52 through the inlet port 42 through the use of a fan (not shown), which is housed within the electronics chamber 50. The air flows up through an air hose 56 in the direction of an air flow direction arrow 60. The air hose 56 is a flexible, corrugated hose standard for providing air flow through a defined path. The air hose 56 extends between an inlet end 62 and an outlet end 64. The inlet end 62 is secured to an air exhaust port 66 formed in the housing 12.

The PAPR assembly 10 also includes a hood system, generally shown at 70. The hood system is connected to the outlet end 64 of the air hose 56 in a manner that provides fluid communication from the housing 12 to the hood system 70. The hood system 70 includes a head cover 72 that is loose fitting allowing for comfort when worn by the user. The head cover 72 is fabricated from a compound that is approximately 60% polyester and 40% natural rubber. The head cover 72 includes a polyvinyl chloride film and a fluoroplastic porous film comprising a polyester-polyolefin non-woven cloth with a polytetrafluorethylene porous membrane. The head cover 72 is held in place by a suspension band 73. The head cover 72 may be an impervious barrier to air flow preventing air from flowing in either direction. The hood system 70 also includes a transparent face shield 74. The transparent face shield 74 allows the user to see out from under the hood system 70, while allowing others to see into the hood system 70. The transparent face shield 74 allows the user to perform tasks while wearing the PAPR assembly 10, while providing facial recognition required by some electronics and security systems. In addition, the transparent face shield 74 is an impervious barrier to air flow so air does not pass through the transparent face shield 74 in either direction.

The hood system 70 includes a hood 76 that is fixedly secured to the head cover 72 and the face shield 74. The hood 76 is made from three layered filter material including a PTFE porous membrane sandwiched between two PET/PE nonwoven fabrics. This filter material is capable of filtering at least 95% of the particulate that is borne in the air that is exhausted by the user. The exhausted air exits the hood system 70 through the hood 76 in the direction of exhaust air arrow 80. While the hood 76 may facilitate bidirectional airflow, the PAPR assembly 10 does not require it because the positive air pressure going into the hood system 70 results in the hood 76 acting as a barrier allowing filtered air to exit therethrough.

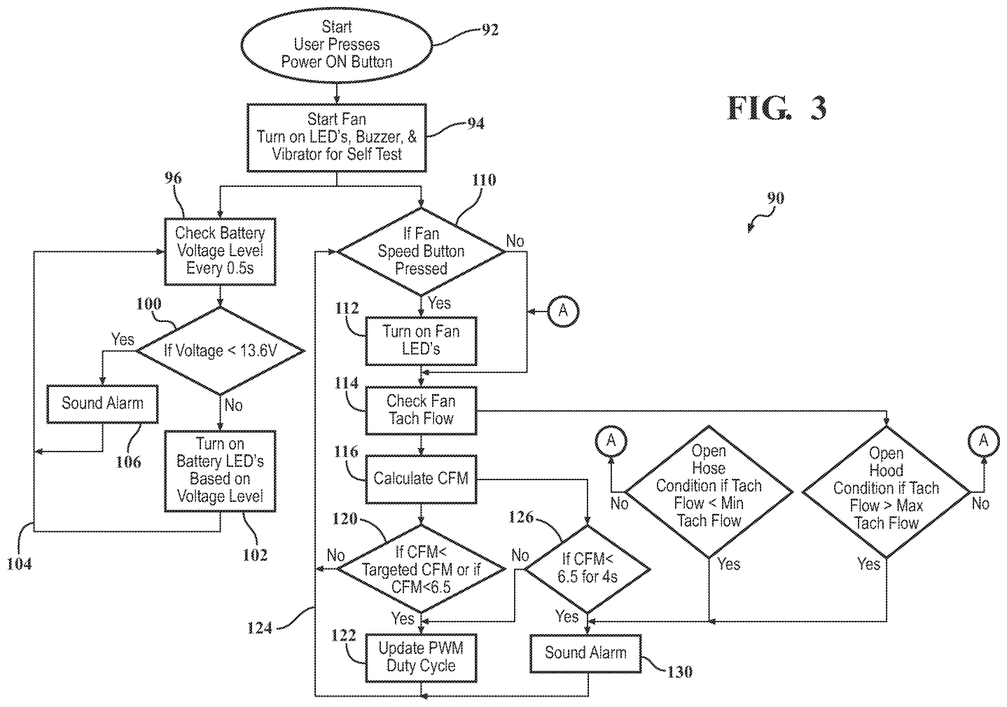

Referring to FIG. 3, a logic chart of the method of using the PAPR assembly 10 is generally indicated at 90. The method provides the ability to warn a user that the air flow produced by the PAPR assembly 10 is inappropriately too low or too high. Reasons for airflow to be inappropriately low include, but are not limited to, inappropriate motor function, a kinked air hose 56, and a clogged filter. Reasons for airflow to be inappropriately too high include inappropriate motor function, an unseated air filter, an air filter with a hole, and a misfitted hood system 70. The misfitted hood system 70 may provide space between the hood 72 and the body of the user, which would allow air to enter and exit the hood system 70 unfiltered. It should be appreciated by those skilled in the art that there may be several other reasons why the airflow is too low or too high, and that the lists set forth above are non-exhaustive.

The method 90 begins at 92 with the press of the start button, which may also be the power on/off button 24. When this button 24 is depressed, the method 90 enters into a startup mode at 94 and cycles through several initiation steps, including, but not limited to, turning on LEDs, sound buzzers and alarms, initiating the vibration device, cycling through all of the fan speeds.

Immediately upon startup, the method 90 checks the battery voltage level at 96. The voltage measurements occur every 0.5 seconds. It is determined at 100 if the battery voltage is less than 13.6V. If it is greater than 13.6 V, the method 90 turns the appropriate LEDs 32 on at 102. The method 90 loops back at 104 to continue with the battery voltage checks at 96. If the voltage level is less than 13.6V, an alarm is activated at 106. Even though the alarm is activated, the method 90 continues to loop back at 104 and retest the voltage level at 96. The alarm may be an audible alarm, a visual alarm, or a haptic alarm, or any combination thereof.

In parallel with the battery voltage level check subroutine, the method 90 determines whether one of the fan speed buttons 26, 30 was pressed at 110. If so, the appropriate fan speed LEDs 34 are illuminated at 112. If not, the method 90 begins to check the fan tachometer at 114.

After the fan tachometer is checked, the amount of airflow is measured at 116. This measurement is in cubic feet per minute (CFM) and can be done through a computational algorithm or through use of a sensor, such as a pressure gradient sensor.

It is then determined at 120 if the airflow measurement in CFM is less than a predetermined low airflow value. In the embodiment shown, the predetermined low airflow value is less than 6.5 CFM. If so, the pulse width modulated duty cycle of the fan motor is adjusted accordingly at 122 and the method 90 loops back at 124 to determine if the fan speed has been adjusted at 110. If the duty cycle of the fan motor does not have to be adjusted, the method 90 loops back at 124 to determine if the fan speed has been adjusted at 110.

If the airflow measurement at 116 results in a CFM that is less than 6.5 for four seconds or more, as measured at 126, an alarm is sounded at 130 and the method 90 loops back at 124 to see if the fan speed is being altered at 110. If the airflow is not below 6.5 CFM for more than four seconds, the method 90 updates the fan motor duty cycle at 122. It should be appreciated by those skilled in the art that the predetermined time of four seconds may be modified up or down depending on the particular embodiment and/or deployment of the PAPR assembly 10.

Additionally, the method 90 determines if open hose or open hood conditions are occurring at 132 and 134, respectively. If either are occurring, the alarm is sounded at 130. If not, the method 90 loops back through “A” and checks the fan tachometer at 114. In this manner, the user can identify when the user is at risk on not being able to properly filter the air being inhaled and exhaled, which is important because sometimes it is hard to identify these situations of inferior operation.

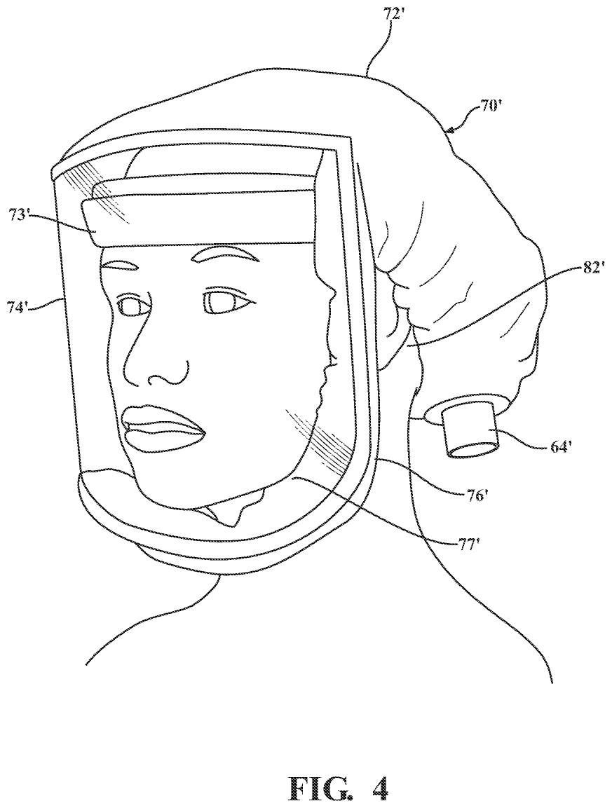

Referring to FIG. 4, wherein like primed reference numerals represent similar elements as those discussed above, the hood 76′ is shown to extend around the face shield 74′. The hood 76′ includes an elastic band 77′ to help enclose the space around the wearer's face preventing exhalation from exiting the hood system 70′ before being filtered by the hood 76′. The head cover 72′ is also fabricated from the filter material discussed above and allows air to pass therethrough, if necessary. The head cover 72′ extends down around the wearer's hairline on her neck. The head cover 72′ also includes a head band 82′ that wraps around the neck hairline of the wearer to prevent unfiltered air from exiting the hood system 70′ without being filtered. The total enclosure of the hood system 70′ allows for accurate diagnosis of when the hood system 70′ is fitted properly and when it needs to be adjusted because it is not.

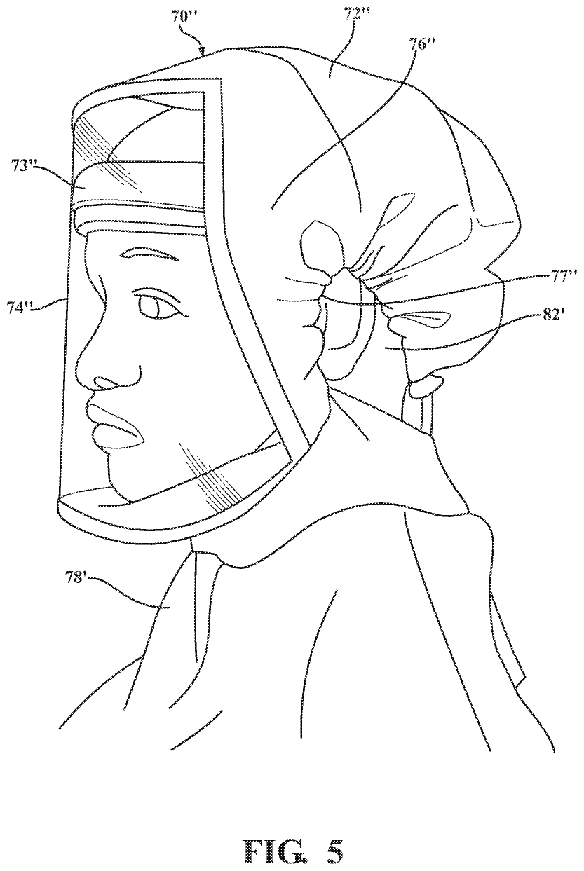

Referring to FIG. 5, wherein like primed double-numerals represent similar elements as those discussed above, the hood 76″ includes a neck bib 78″. The neck bib 78″ is connected to the hood 76″ at a location disposed adjacent the elastic band 77″ and extends down from the hood 76″ to cover the neck of the wearer. The provides additional filter media surface area that may assist in filtering exhaust air that might escape from the hood 76″.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A method for alerting a user that a volume of air being circulated through a powered air purifying respirator assembly, having a fan and a hood system, is outside an acceptable range, the method comprising the steps of:
measuring airflow through the powered air purifying respirator assembly to create a measured airflow value;
comparing the measured airflow value to a predetermined high airflow value; and
generating an alarm signal when the measured airflow value is greater than the predetermined high airflow value.

2. A method as set forth in claim 1 wherein the step of generating an alarm signal is inhibited until the measured airflow value is greater than the predetermined high airflow value for a time greater than a set time period.

3. A method as set forth in claim 2 including the step of comparing the measured airflow value to a predetermined low airflow value.

4. A method as set forth in claim 3 including the step of increasing the speed of the fan to increase the airflow through the powered air purifying respirator assembly.

5. A method as set forth in claim 4 including the step of generating the alarm signal when the measured airflow value is less than the predetermined value.

6. A method as set forth in claim 5 wherein the step of generating an alarm signal is inhibited until the measured airflow value is less than the predetermined low airflow value for a time greater than the set time period.

7. A method for alerting a user that a volume of air being circulated through a powered air purifying respirator assembly, having a fan and a hood system, is outside an acceptable range, the method comprising the steps of:
measuring airflow through the powered air purifying respirator assembly to create a measured airflow value;
comparing the measured airflow value to a predetermined high airflow value;
comparing the measured airflow value to a predetermined low value; and
generating an alarm signal when the measured airflow value is greater than the predetermined high airflow value or less than the predetermined low airflow value.
